(19) United States
(12) Patent Application Publication
(10) Pub. No.: US 2006/0188705 A1
(43) Pub. Date: Aug. 24, 2006

(54) Interstitial insulation

(75) Inventor: Leroy S. Fletcher, College Station, TX (US)

Correspondence Address: CONLEY ROSE, P.C., P. O. BOX 3267, HOUSTON, TX, 77253-3267, US

(73) Assignee: The Texas A&M University System, College Station, TX (US)

(21) Appl. No.: 11/339,644

(22) Filed: Jan. 25, 2006

Related U.S. Application Data
(60) Provisional application No. 60/646,765, filed on Jan. 25, 2005.

(51) Int. Cl. B32B 3/26

(52) U.S. Cl. 428/304.4

(57) ABSTRACT

A device and method for interstitially insulating a region. In an embodiment, the interstitial insulation comprises a material. In addition, the interstitial insulation comprises a layer mounted to the material. Further, the interstitial insulation comprises an interstice disposed between the material and the layer, wherein the interstice is sufficient to reduce heat transfer across the interstitial insulation.

### CROSS-REFERENCE TO RELATED APPLICATIONS

This non-provisional application claims the benefit of U.S. Provisional Application No. 60/646,765, filed Jan. 25, 2005, which is hereby incorporated by reference in its entirety.

### STATEMENT REGARDING FEDERALLY SPONSORED RESEARCH OR DEVELOPMENT

This invention was made with Government support under research contracts from the Marine Mineral Service (MMS) (MMS Project #509) under Contract No. 0104RU35515. The government may have certain rights in this invention.

### BACKGROUND OF THE INVENTION

1. Field of the Invention

The present invention relates generally to the field of insulating materials, and more particularly relates to the field of interstitially insulated materials.

2. Background of the Invention

Insulating materials are generally used as a barrier to the flow of energy, usually heat. Insulating materials are used, for example, on pipes, building walls, refrigerated vessels, ovens, and other appliances or industrial applications where it is important to minimize the flow of thermal energy from a relatively warmer region to a relatively cooler region.

Numerous approaches have been explored in the past for different insulating material designs and techniques, both on the interior and on the exterior of the insulating material. Some conventional techniques involve the use of insulating coatings on the inside or outside surface of the insulating material. However, such coatings may wear off over time, especially when there is physical contact with the coating. In addition, some coatings may also degrade over time, reducing their effectiveness. Other conventional insulating techniques involve the use of multiple layers of insulating material(s). However, it may not be practical or economically feasible to obtain the desired insulating capabilities (e.g., thermal resistance, thermal performance, etc.) with such techniques. Further, multiple layers of insulating material(s) may complicate the handling, manipulation, and installation of such insulating materials. For example, some conventional insulating materials may be particularly sensitive to bending, impact loads, pressure, etc. Bending, excessive pressure, or damage to such insulating materials may reduce their insulating effectiveness. In addition, some multi-layered insulating materials may present manufacturing complexities.

Consequently, there is a need for improved insulating materials and methods that provide an improvement in thermal performance over existing materials (e.g., improved thermal resistance). In addition, there is a need for insulating materials and methods which reduce or eliminate the need for interior coatings. Further, needs include improved insulating materials and methods that are easier to handle, manipulate, and install. Still further, needs include improved insulating materials and methods that may permit bending of the insulating material without detrimentally affecting the thermal performance of the insulating material. In addition, needs include improved insulating materials and methods that are relatively simple to manufacture.

### BRIEF SUMMARY OF SOME OF THE PREFERRED EMBODIMENTS

These and other needs in the art are addressed in one embodiment by an interstitial insulation for insulating a region. In an embodiment, the interstitial insulation comprises a material. In addition, the interstitial insulation comprises a layer mounted to the material. Further, the interstitial insulation comprises an interstice disposed between the material and the layer, wherein the interstice is sufficient to reduce heat transfer across the interstitial insulation

These and other needs in the art are addressed in another embodiment by an interstitially insulated tubular. In an embodiment, the interstitially insulated tubular comprises an inner tubular. In addition, the interstitially insulated tubular comprises an outer tubular mounted coaxially to the inner tubular. Further, the interstitially insulated tubular comprises an interstice disposed between the inner tubular and the outer tubular, wherein the interstice is sufficient to reduce heat transfer across the interstitially insulated tubular.

These and other needs in the art are addressed in another embodiment by a method of reducing thermal energy flow across a material. In an embodiment, the method comprises mounting a layer to a material. In addition, the method comprises minimizing the contact surface area between the material and layer. Further, the method comprises providing an interstice between the material and layer, wherein the interstice reduces heat transfer between the material and the layer.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates a partial sectional view of an uninsulated wall;

FIG. 2 illustrates an end view of an embodiment of an interstitial insulation;

FIG. 3 illustrates a partial sectional view of the embodiment of the interstitial insulation illustrated in FIG. 2;

FIG. 4 illustrates an end view of an embodiment of an interstitial insulation with additional layers;

FIG. 5 illustrates a partial sectional view of the embodiment of the interstitial insulation illustrated in FIG. 4;

FIG. 6 illustrates a front view of a variety of geometries for the separator of the interstitial insulation illustrated in FIGS. 2 and 3;

FIG. 7 illustrates a partial sectional view of an embodiment of the interstitial insulation of FIGS. 2 and 3 formed into an interstitially insulated tubular;

FIG. 8 illustrates a partial sectional view of an embodiment of the interstitial insulation of FIGS. 4 and 5 formed into an interstitially insulated tubular;

FIG. 9 illustrates a front view of a test specimen utilized in the experiment described in EXAMPLE 1;

FIG. 10 illustrates a front view of the Thermal Contact Conductance (TCC) system utilized to conduct the experiments described in EXAMPLES 1, 2, and 3;

FIG. 11 graphically illustrates the results for the stainless steel screen mesh specimens tested in EXAMPLE 1;

FIG. 12 graphically illustrates the results for the titanium screen mesh specimens and stainless steel 5 screen mesh specimens tested in EXAMPLE 1;

FIG. 13 graphically illustrates the results for the tungsten screen mesh specimens and the stainless steel 5 screen mesh specimens tested in EXAMPLE 1;

FIG. 14 graphically illustrates the results for the stainless steel 5 screen mesh specimens tested in EXAMPLE 2 compared to existing pipe technology;

FIG. 15 illustrates a front view of a test specimen utilized in the experiment described in EXAMPLE 3; and

FIG. 16 graphically illustrates the results for the inconel screen mesh specimens tested in EXAMPLE 3.

### DETAILED DESCRIPTION OF THE PREFERRED EMBODIMENTS

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

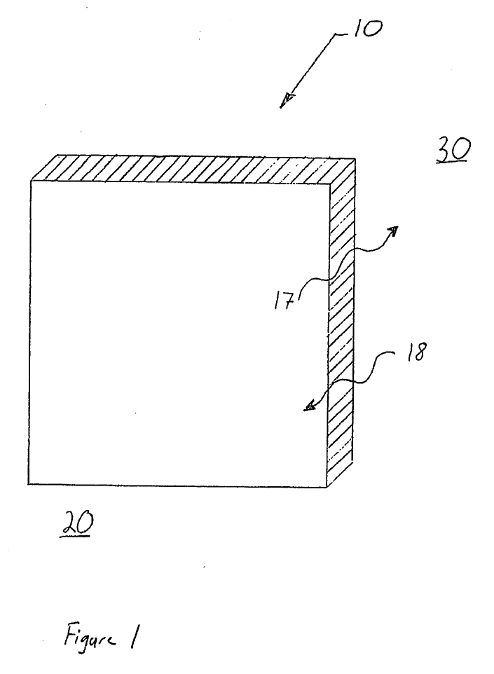

FIG. 1 illustrates an uninsulated wall 10. Wall 10 physically separates a first region 20 and a second region 30. If first region 20 is at a higher temperature than second region 30, thermal energy will flow from first region 20 across wall 10 to second region 30 in the direction of arrow 17. Without being limited by theory, the flow of thermal energy from a warmer region to a cooler region may be due to conduction, convention, radiation, or combinations thereof. The flow of thermal energy across wall 10 in the direction of arrow 17 may result in heat loss and a decrease in temperature of first region 20, and a heat gain and increase in temperature in second region 30. Alternatively, if the first region 20 is at a lower temperature than second region 30, thermal energy may flow from second region 30 across wall 10 to first region 20 in the direction of arrow 18. The flow of thermal energy across wall 10 in the direction of arrow 18 may result in heat loss and a decrease in temperature of second region 30, and a heat gain and increase in temperature in first region 20. The flow of thermal energy may continue as long as a temperature differential exists between first region 20 and second region 30.

Without being limited by theory, the actual rate of heat transfer across wall 10 due to a temperature differential between first region 20 and second region 30 may be determined by any academically or industrially accepted method (e.g., calculation, experimentation, etc.). It is to be understood that the reference to first region 20 and second region 30 is relative. However, it is intended that first region 20 refers to a volume to be insulated (e.g., the inside of a refrigerated vessel, the inside of an insulated pipe, etc.), while second region 30 refers to the volume to be thermally separated from first region 20 (e.g., region outside the refrigerated vessel, region outside the insulated pipe, etc.).

Without being limited by theory, the ability of a material (e.g., wall 10 ) to resist the flow of thermal energy may depend on the thermal resistance of the material. Thermal resistance refers to a resistance to the flow of thermal energy resulting from conduction, convection, radiation, or combinations thereof. Thus, the greater the thermal resistance of a material, the greater the ability of the material to resist the flow of thermal energy from one side of the material to the other. Since the purpose of an insulating material is to minimize the flow of thermal energy between regions of different temperatures, it may be desirable to have an insulating material with a relatively high thermal resistance.

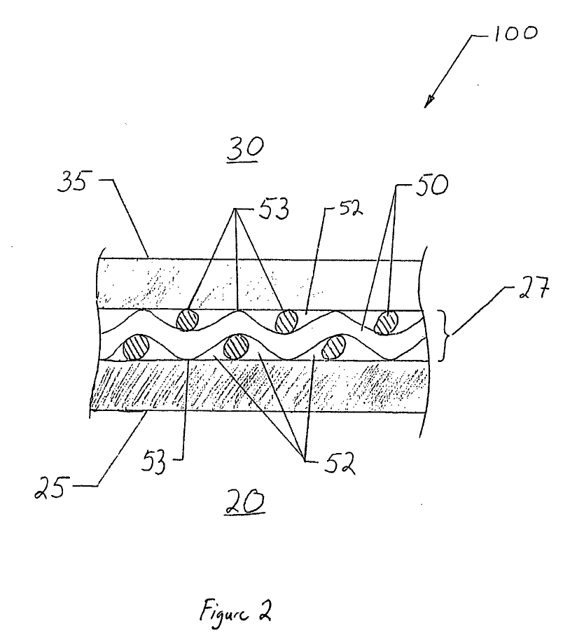

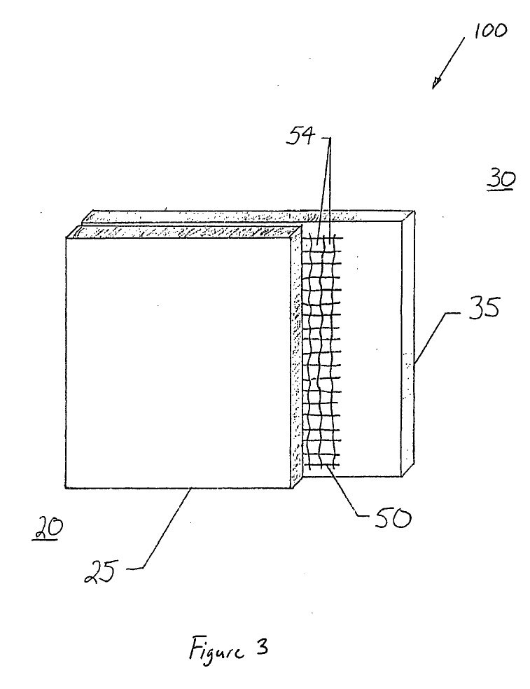

FIGS. 2 and 3 illustrate an interstitial insulation 100 comprising a material 25, an interstice 27, and a layer 35. Interstice 27 is located between material 25 and layer 35. Material 25 faces a first region 20, while layer 35 faces a second region 30. A separator 50 is provided in interstice 27. Separator 50 prevents material 25 from contacting layer 35. Although interstice 27 illustrated in FIGS. 2 and 3 includes a separator 50, in certain embodiments (not illustrated), no separator 50 is provided in interstice 27 between material 25 and layer 35.

In the embodiment illustrated in FIGS. 2 and 3, separator 50 is a screen mesh disposed between material 25 and layer 35. In particular, when separator 50 is a screen mesh, contact points 53 exist between material 25 and separator 50, and contact points 53 exist between layer 35 and separator 50. Further, gaps 52 exist between material 25 and separator 50, and gaps 52 exist between layer 35 and separator 50. Still further, separator 50 illustrated in FIG. 3 includes holes 54. Holes 54 are in the separator 50, while the gaps 52 are the spaces between the inner surface of material 25 and separator 50 and the spaces between the inner surface of layer 35 and the separator 50.

Interstitial insulation 100 provides a thermal barrier between first region 20 and second region 30. Without being limited by theory, by serving as a thermal barrier (i.e., insulating material), interstitial insulation 100 resists the flow of thermal energy between first region 20 and second region 30 when a temperature differential exists between first region 20 and second region 30. Interstitial insulation 100 may resist the flow of thermal energy from first region 20 to second region 30 (e.g., when first region 20 is at a higher temperature than second region 30), or alternatively, interstitial insulation 100 may resist the flow of thermal energy from second region 30 to first region 20 (e.g.. when second region 30 is at a higher temperature than first region 20).

The inclusion of separator 50 between material 25 and layer 35 may increase the thermal resistance of interstitial insulation 100. Without being limited by theory, in the embodiment illustrated in FIGS. 2 and 3, the increased thermal resistance may be the result of (1) reduced conductive heat transfer between material 25 and layer 35, and (2) limited convective heat transfer between material 25 and layer 35. In some embodiments (not illustrated), a heat reflective material is also included within interstitial insulation 100 to limit radiative heat transfer between material 25 and layer 35.

Still referring to FIG. 2, inclusion of separator 50 between material 25 and layer 35 reduces the contact surface area available for conduction between material 25 and layer 35. For instance, in an embodiment in which separator 50 is a screen mesh, separator 50 reduces the contact surface area available for conduction by providing a limited number of contact points 53 between material 25 and layer 35. In addition, as illustrated in FIG. 3, separator 50 provides gaps 52 and holes 54 between material 25 and layer 35, further reducing the contact surface area available for conduction between material 25 and layer 35. Without being limited by theory, the less contact surface area available for conduction, the less conduction and the greater the thermal resistance. Thus, when the contact surface area between material 25 and layer 35 is reduced, the thermal resistance of interstitial insulation 100 may increase.

As further illustrated in FIGS. 2 and 3, separator 50 also limits convective heat transfer between material 25 and layer 35. Convection between material 25 and layer 35 may be substantially limited to gaps 52 and holes 54 provided in separator 50. Further, gaps 52 and holes 54 may comprise an improved insulator, including without limitation vacuum, air, a fluid, a liquid, foam insulation, or combinations thereof. Preferably, gaps 52 and holes 54 are a vacuum. Thus, inclusion of separator 50 may limit convective heat transfer between material 25 and layer 35, further increasing the thermal resistance of interstitial insulation 100.

In certain embodiments, interstitial insulation 100 comprises additional interstice(s) 27, interstitial layer(s) 35, separator(s) 50, or combinations thereof. The additional interstice(s) 27, interstitial layer(s) 35, separator(s) 50, or combinations thereof may be provided for structural purposes, to improve thermal resistance, or for other reasons.

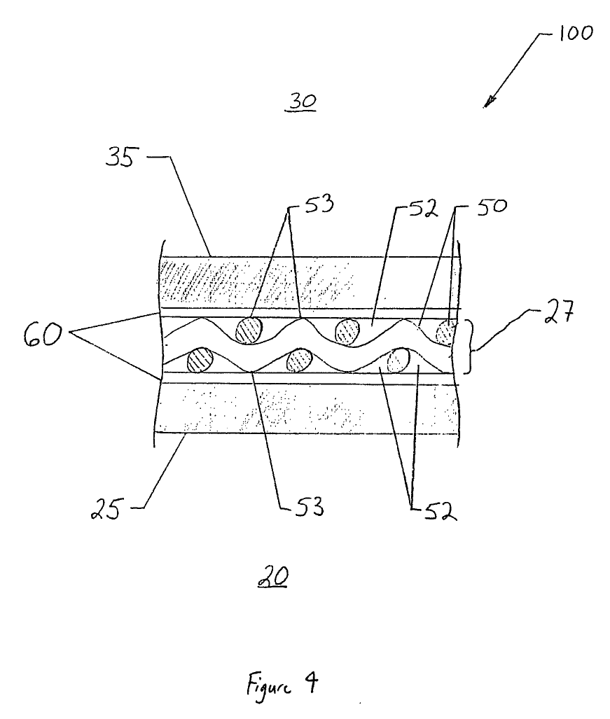

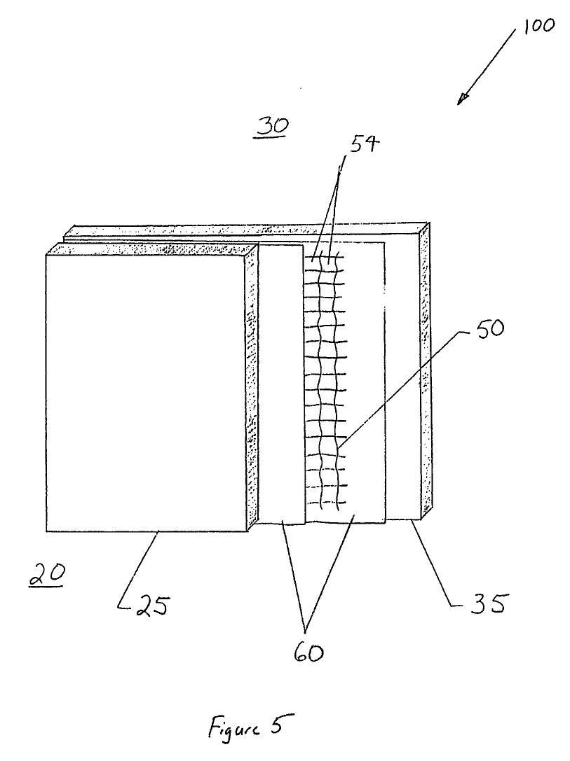

For example, FIGS. 4 and 5 show the embodiment of interstitial insulation 100 illustrated in FIGS. 2 and 3 further comprising two layers of film 60. One layer of film 60 is provided between separator 50 and material 25, and a second layer of film 60 is provided between separator 50 and layer 35. Without being limited by theory, the inclusion of film 60 may improve the thermal resistance of interstitial insulation 100 by allowing for the collection of gaps 52 and holes 54 of a particular and precise thickness. Film 60 may comprise any suitable material, including without limitation a polymer (e.g., Mylar®), a coated polymer (e.g., aluminized Mylar®), a heat reflective material, etc.

In addition to increasing the thermal resistance of interstitial insulation 100, inclusion of separator 50 maintains the separation of material 25 and layer 35 (i.e., prevents material 25 from contacting layer 35). Thus, in some embodiments (not illustrated), interstitial insulation 100 may be curved, bent, placed under pressure, sustain an impact load, or combinations thereof without material 25 contacting layer 35. By preventing material 25 from contacting layer 35, the thermal performance of interstitial insulation 100 is maintained even if curved, bent, subjected to pressure, subjected to an impact load or combinations thereof. In some embodiments (not illustrated), some contact may occur between material 25 and layer 35, but separator 50 may reduce the contact in such instances.

Referring again to FIGS. 2 and 3, material 25 may comprise materials such as, without limitation, metals and metal alloys (e.g., stainless steel, aluminum, iron, carbon steel etc.), non-metals (e.g., polymer, rubber, composite, ceramic, wood, etc.), or combinations thereof. In addition, material 25 may comprise a rigid material (e.g., steel, titanium, etc.), a non-rigid material (e.g., rubber, plastic, etc.), or combinations thereof. Further, depending on the contents of first region 20 and/or the contents of interstice 27 between material 25 and layer 35 (e.g., contents of gaps 52 and holes 54), material 25 may comprise a corrosive resistance material (e.g., stainless steel, zinc, etc.) or have a protective coating (e.g., plastic, protective paint, etc.) to minimize corrosion. For example, if first region 20 contains an acidic solution and material 25 comprises a material susceptible to acidic corrosion, a protective coating may be provided on the surface of material 25 facing region 20 to reduce the corrosion of material 25 by the acidic solution contained in region 20.

Similarly, layer 35 may comprise any suitable material, including without limitation metals and metal alloys (e.g., stainless steel, aluminum, iron, carbon steel, etc.), non-metals (e.g., polymer, rubber, composite, wood, etc.), or combinations thereof. Further, layer 35 may comprise a rigid material (e.g., steel, titanium, etc.), a non-rigid material (e.g., rubber, plastic, etc.), or combinations thereof In addition, depending on the contents of second region 30 and/or interstice 27 between material 25 and layer 35 (e.g., gaps 52 and/or holes 54), layer 35 may comprise a corrosive resistance material (e.g., stainless steel, zinc, etc.) or a protective coating (e.g., plastic, protective paint, etc.) to reduce corrosion of layer 35. For instance, if second region 30 contains salt water and layer 35 comprises a material susceptible to corrosion by salt water, a coating may be provided on the surface of layer 35 facing second region 30 to reduce the corrosion of layer 35 by the salt water contained in second region 30. Still further, material 25 and layer 35 may comprise the same or different materials.

Still referring to FIGS. 2 and 3, separator 50 may comprise any suitable material including metals and metal alloys (e.g., iron, steel, aluminum, etc.), non-metals (e.g., polymer, composites, ceramic, foam, water, etc.), or combinations thereof. In some embodiments, the selection of material(s) for separator 50 may be influenced by the pressure exerted on separator 50 by material 25, layer 35, or combinations thereof. For example, if the contact pressure exerted on separator 50 by material 25 and layer 35 is relatively high, and deformation of separator 50 is undesirable, then separator 50 may comprise a mechanically rigid material (e.g., stainless steel). However, if some deformation of separator 50 is acceptable, then separator 50 may comprise a less mechanically rigid material (e.g., foam, rubber, etc.). In some embodiments, for instance when separator 50 is a screen mesh, the selection of material(s) for separator 50 may be influenced by the pressure exerted on separator 50 at contact points 53. Further, when separator 50 is a screen mesh, separator 50 preferably comprises a metal or metal alloy with a relatively high thermal resistance (i.e., a relatively low thermal conductivity), including without limitation stainless steel, titanium, neodymium, inconel alloys, tungsten, etc. These preferred materials provide a relatively high thermal resistance (i.e., a relatively low thermal conductivity) and provide rigidity to prevent material 25 from contacting layer 35 when interstitial insulation 100 is bent, placed under pressure, sustains an impact load, or combinations thereof.

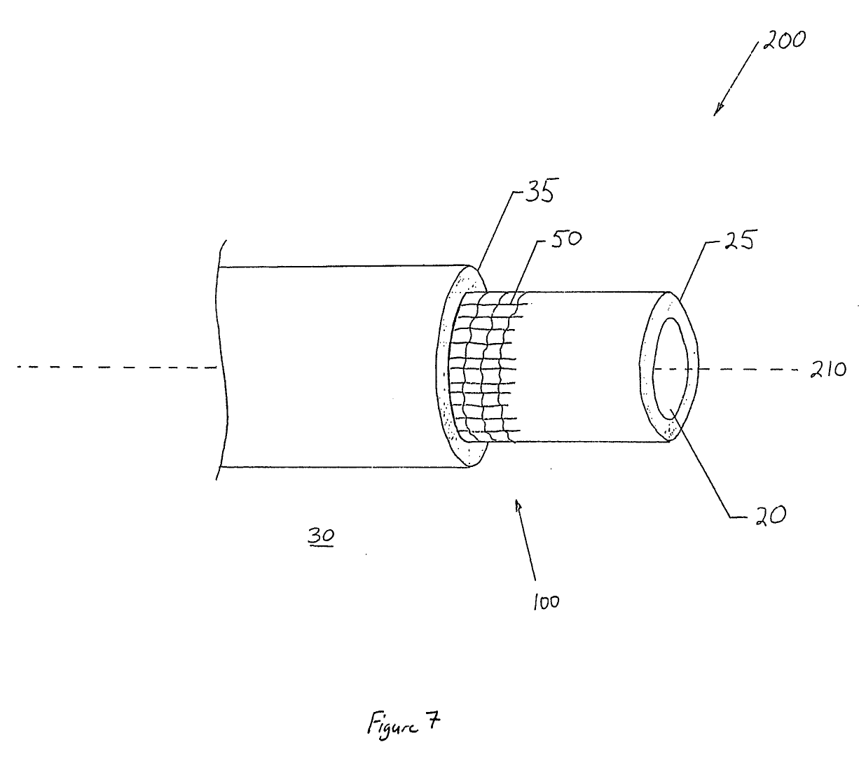

In some embodiments, as illustrated in FIG. 7, separator 50 may be a flexible material capable of being formed to a desired geometry, often depending on the geometry of material 25 and layer 35. Further, depending on the environment, separator 50 may comprise a corrosive resistance material and/or include a corrosive resistance coating.

In addition, the range of temperatures of first region 20 and second region 30 may influence the materials selected for separator 50, material 25, and layer 35.

In general, separator 50 may comprise any suitable geometry, including without limitation a screen mesh, a solid block of material, a continuous sheet, a ribbed film, a flowing fluid, a static fluid, etc. Preferably, separator 50 comprises a geometry that both prevents material 25 from contacting layer 35 and improves the thermal resistance of interstitial insulation 100. In certain embodiments (not illustrated), welded projections or other elements between material 25 and layer 35 replace separator 50 and hold material 25 apart from layer 35 to provide an interstitial insulating gap. For instance, welded projections may include raised metal dots, raised metal ridges, raised ribs, etc.

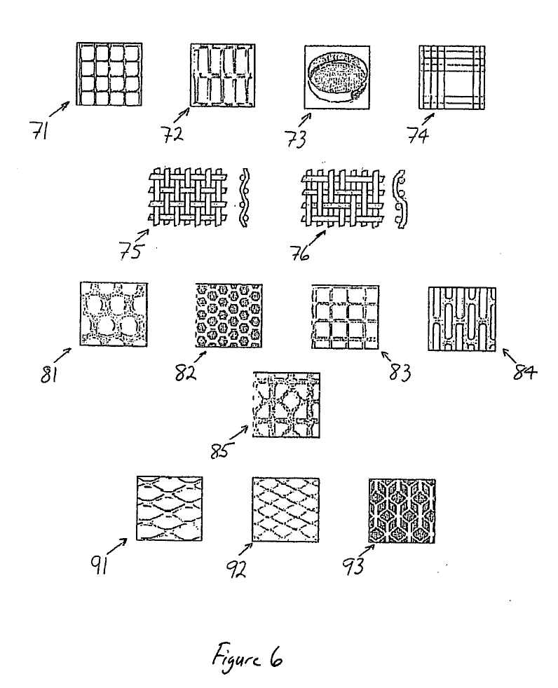

In FIGS. 2-5, 7, and 8, separator 50 is a screen mesh. In particular, when separator 50 is a screen mesh, separator 50 may comprise any suitable mesh geometry, including without limitation weave geometries, non-weave geometries (e.g., perforated materials, expanded materials, etc.), or combinations thereof. FIG. 6 illustrates a non-exclusive sampling of screen mesh geometries for separator 50. For instance, separator 50 may comprise a square mesh 71, a rectangular mesh 72, a sieved mesh 73, an architectural mesh 74, etc. Further, separator 50 may comprise a plain weave 75, a twill weave 76, etc. As an alternative to a weave configuration, separator 50 may comprise a non-weave geometry, including without limitation a perforated material (e.g., round perforations 81, hexagonal perforations 82, square perforations 83, slotted perforations 84, decorative perforations 85, etc.), an expanded material (e.g., flattened expansions 91, standard expansions 92, decorative expansions 93, etc.), or combinations thereof.

Further, when separator 50 is a screen mesh, holes 54 may comprise any suitable shape including without limitation rectangular, elliptical, hexagonal, etc. Still further, when separator 50 is a screen mesh, separator 50 may comprise any desirable mesh size (e.g., size 2 mesh, size 5 mesh, size 10 mesh, size 100 mesh, etc.), mesh spacing, and mesh wire diameter.

In general, the surfaces of material 25, layer 35, and separator 50 may be of any suitable texture, including without limitation smooth, polished, irregular, knurled, rough, or combinations thereof. Referring to FIGS. 2 and 3, the surfaces of material 25, layer 35, and separator 50 are smooth. Without being limited by theory, smooth surfaces generally reduce radiative heat transfer by reflecting heat. However, without being limited by theory, irregular contact surfaces (e.g., rough, knurled, etc.) reduce conductive heat transfer by reducing the contact surface area available for conduction. Thus, in some embodiments (not illustrated), the surfaces of material 25, layer 35, separator 50 or combinations thereof are irregular. In select embodiments (not illustrated), separator 50 is replaced by a heavily knurled material 25 surface, a heavily knurled layer 35 surface, or combination thereof.

Separator 50, material 25 and layer 35 may be held together by any suitable means, including without limitation spot welding, press fitting, adhesive, vacuum, static pressure, or combinations thereof.

FIG. 7 illustrates an interstitially insulated tubular 200 made of interstitial insulation 100 shown in FIGS. 2 and 3. Interstitially insulated tubular 200 comprises material 25 having a tubular configuration (e.g., inner tubular), layer 35 having a tubular configuration (e.g., outer tubular), and interstice 27 (not shown) between material 25 and layer 35. A separator 50 is provided in interstice 27 between material 25 and layer 35. Material 25 and layer 35 are essentially coaxial tubes sharing the same radial axis 210.

Material 25 completely surrounds first region 20. Further, separator 50 is disposed between material 25 and layer 35. Separator 50 contacts the outside surface of material 25 and the inside surface of layer 35. In the embodiment illustrated in FIG. 7, separator 50 is a screen mesh that contacts material 25 and layer 35 at a limited number of contact points 53 (not illustrated). In addition, separator 50 maintains the separation of material 25 and layer 35. The interstitially insulated tubular 200 provides a thermal barrier between first region 20 and a second region 30. Without being limited by theory, by providing a thermal barrier, interstitially insulated tubular 200 may reduce the transfer of thermal energy between first region 20 and second region 30.

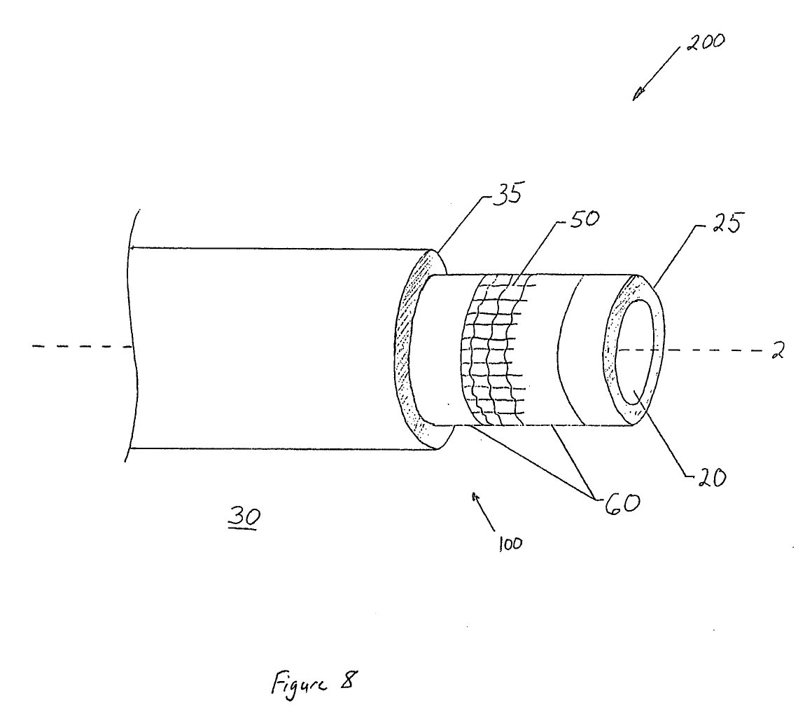

In the embodiment shown in FIG. 7, one layer 35 and one separator 50 are provided in interstitially insulated tubular 200. However, in some embodiments (not illustrated), additional interstitial tubular(s) (e.g., material 25, layer 35) and/or separator(s) 50 may be added to interstitially insulated tubular 200. Additional layer(s) and/or separators 50 may be added for structural purposes, to improve thermal resistance, or for other reasons. For example, FIG. 8 shows an interstitially insulated tubular 200 made of the interstitial insulation 100 illustrated in FIGS. 4 and 5. Interstitially insulated tubular 200 shown in FIG. 8 comprises two additional layers of film 60.

An embodiment of interstitially insulated tubular 200 illustrated in FIG. 7 may be used to construct a subsea oil/gas pipeline, a riser, a transfer line (e.g., LNG transfer line), or the like. As an example, in such an application, material 25 (e.g., inner tubular) may comprise a carbon steel pipe with a first region 20 flowing relatively warm crude oil at temperature of about 70° to 76° C. (1600 to 170° F.). Second region 30 may comprise seawater with a temperature of about 0° C. to 2° C. (32° F. to 35° F.). Without adequate thermal resistance, sufficient thermal energy may flow from the warmer crude oil in first region 20 to the cooler seawater in second region 30 to result in a reduction in the crude oil temperature to below the paraffin cloud point, about 68° C. (155° F.). Below the paraffin cloud point, paraffin wax in the crude oil may begin to crystallize into solid particles and deposit on the inside surface of material 25. The buildup of paraffins on the inside surface of material 25 may ultimately lead to blockage of the pipeline.

Without being limited by theory, the improved thermal resistance provided by interstitially insulated tubular 200, made of interstitially insulating material 100, may maintain the temperature of the crude oil above the paraffin cloud point, thereby reducing or eliminate the need for the various approaches to prevent and/or minimize paraffin buildup (e.g., chemical additives, coatings, pigging, etc.). Further, in certain embodiments (not illustrated), interstitially insulated tubular 200 may be more flexible than conventional oil/gas pipelines, being able to withstand bending, impact loads, and/or pressure without a reduction in thermal performance. In addition, the improved flexibility provided by some embodiments of interstitially insulated tubular 200 may simplify installation and movement of the pipeline. Still further, select embodiments of interstitially insulating pipe 200 (not illustrated), have an overall outside diameter less than conventional externally insulated oil/gas pipelines and are therefore easier to transport and install.

If a pipeline or riser is composed of pipe sections made of interstitially insulated tubular 200, then any connections and/or couplings between such sections are preferably adequately insulated to ensure the benefits of the interstitially insulated tubular 200. For example, the connections and/or couplings between the pipe sections made of interstitially insulated tubular 200 may be made of a rubber seal, an insulated seal, a seal comprised of interstitial insulation 100, etc. Further, in some embodiments (not illustrated), the connections and/or couplings between pipe sections made of interstitially insulated tubular 200 may be made of a flexible material.

Any suitable method of manufacturing interstitially insulated tubular 200 may be employed, including without limitation shrink fit techniques, hydrostatic pressure techniques, or combinations thereof. For example, in an embodiment (not illustrated), layer 35 (e.g., outer tubular) is a length of carbon steel pipe and material 25 (e.g., inner tubular) is a thin wall carbon steel pipe with an external diameter equal to the inside diameter of the outer tubular. Further, separator 50 is made of a length of stainless steel screen wire whose width is about the same as the exterior circumference of the inner tubular. Separator 50 may be carefully wrapped around the outside surface of the inner tubular and spot welded to the outside surface of the inner tubular in suitable locations to hold the separator 50 in place. Then, the inner tubular is cooled and the outer tubular is heated. Next, the inner tubular, including the attached separator 50, is slid coaxially within the outer tubular. Once the inner tubular, including the attached separator 50, is placed coaxially within the outer tubular, the outer tubular is allowed to cool and shrink fit around separator 50 and the inner tubular to provide interstitially insulated tubular 200.

A hydrostatic pressure technique may be used as an alternate manufacturing method. For example, in an embodiment (not illustrated), layer 35 (e.g., outer tubular) is made of a carbon steel pipe and material 25 (e.g., inner tubular) is made of a carbon steel pipe with an outside diameter less than the inside diameter of the outer tubular. Further, separator 50 is a stainless steel mesh whose width is about the same as the interior circumference of the outer tubular. Separator 50 is installed on the inside surface of the outer tubular. Then, the inner tubular is slipped coaxially into the outer tubular and separator 50. Next, a hydrostatic pressure process or other technique is used to expand the inner tubular into separator 50 to provide interstitially insulated tubular 200.

It is to be understood that there may be other techniques for fabricating interstitially insulated tubular 200 in addition to the hydrostatic pressure and the shrink fit techniques. Further, a variety of materials and thicknesses of material 25, separator 50, and layer 35 may be selected for ease of manufacture.

In the manner described, embodiments of the present invention present an improved insulation material and techniques. The interstitially insulated material may be used for many insulation purposes. For instance, it can be used as insulation for insulating pipes, couplings, flanges, risers, transfer lines (e.g., LNG transfer lines), walls, tanks, vessels, valves, and the like.

The interstitial insulation 100 and methods described overcome various problems with conventional insulating techniques. For instance, certain embodiments of interstitial insulation 100 may yield an improvement in thermal resistance as compared to current insulating materials. Further, some embodiments of interstitial insulation 100 may be more flexible and less sensitive to bending, impact loads, and pressure both during and after installation. For instance, due to separator 50 (e.g., interstitial screen mesh), material 25 and layer 35 (e.g., the first and second walls of the interstitial insulation 100) may not contact each other when bent or when placed under pressure. Still further, other embodiments of interstitial insulation 100 may reduce or eliminate the need for chemical additives, special internal wall coatings, and pigging in used to prevent paraffin buildup in oil/gas pipelines. In addition, in certain embodiments, interstitial insulation 100 may be thinner and therefore easier to transport, assemble and install than conventional insulating materials. Still further, select embodiments of interstitial insulation 100 may be less complex to manufacture than conventional insulating materials.

While preferred embodiments of this invention have been shown and described, modifications thereof can be made by one skilled in the art without departing from the scope or teaching of this invention. The embodiments described herein are exemplary only and are not limiting. Many variations and modifications of the system and apparatus are possible and are within the scope of the invention. For example, the relative dimensions of various parts, the materials from which the various parts are made, and other parameters can be varied, so long as the interstitial insulation retains the advantages discussed herein. Accordingly, the scope of protection is not limited to the embodiments described herein, but is only limited by the claims that follow, the scope of which shall include all equivalents of the subject matter of the claims.

### EXAMPLE 1

To quantify the thermal resistance of a variety of screen meshes, controlled experiments were conducted. The experimental conditions were appropriate for simulating deepwater pipeline applications. Steel slugs made of the same material as subsea pipes (“X-60 or X-80” pipe or medium-carbon steel P110 4140) were used to represent the subsea pipe walls.

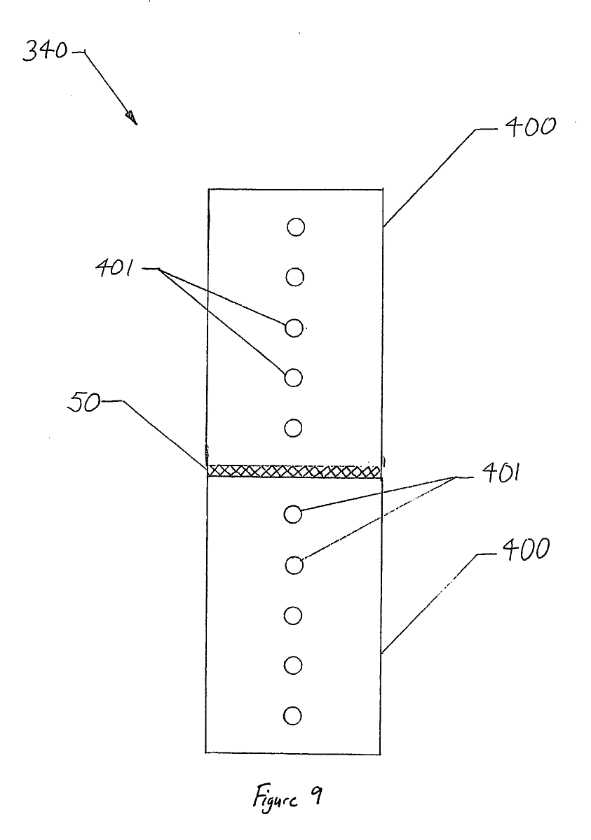

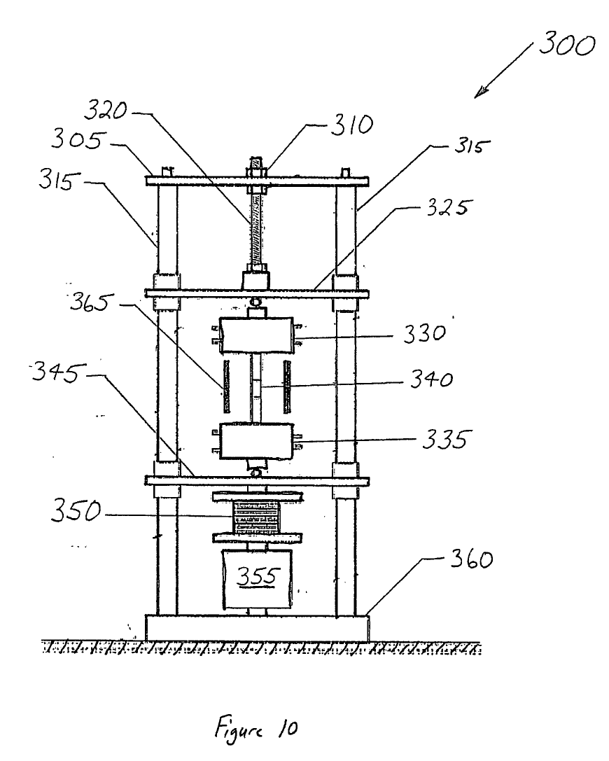

As illustrated in FIG. 9, each test specimen 340 comprised two flux meters 400 and a separator 50 positioned between the flux meters 400. The flux meters 400 were fabricated from the steel slugs. Each flux meter 400 had a length of about 3.81 cm (1.5 in.). Five equally spaced holes 401 were drilled to the center of each steel flux meter 400 in order to affix “T” type thermocouples (not shown). The thermocouples measured the axial temperature distributions in the flux meter 400 during testing. Cutouts of separator 50 with a diameter of 2.54 cm (1 inch) were pressed between two flux meters 400 by the Thermal Contact Conductance (TCC) system 300 illustrated in FIG. 10 and described below.

FIG. 10 illustrates the Thermal Contact Conductance (TCC) system 300 used to conduct the experiments. The TCC system 300 comprises a top plate 305, a lock nut 310, a guide shaft 315, a threaded rod 320, an upper moveable plate 325, a heat source 330, a heat sink 335, a test specimen 340, a lower moveable plate 345, a load bellows 350, a load cell 355, a base plate 360, and a radiation shield 365. The heat source 330 was fastened to the upper moveable plate 325. The temperature of the heat source 330 was controlled according to the desired test parameters. The heat sink 335 was fastened to the lower moveable plate 345. The temperature of the heat sink 335 was controlled according to the desired test parameters. The test specimen 340 was held between the heat source 330 and heat sink 335. To properly position the specimen 340 between the heat source 330 and heat sink 335, the upper moveable plate 325 and heat source were moved, by rotating threaded rod 320 connected to upper moveable plate 325, until the test specimen 340 contacted the heat source 330 and heat sink 335. The linear movement of upper moveable plate 325 and heat source 330 were guided by guide shaft 315. Once the test specimen 340 was properly positioned between the heat source 330 and heat sink 335, the upper moveable plate 325 was fixed by tightening lock nut 310. The radiation shield 365 was provided around the test specimen 340 to minimize radial heat losses. In addition, the test specimen 340 was wrapped by a secured foam insulation cover (not shown) to minimize convective heat losses, and thus ensure that the applied heat flow, from heat source 330 to heat sink, was one dimensional along the radial axis of test specimen 340.

To begin the experiment, the test specimen 340 was loaded by introducing pressure into the load bellows 350, mounted to lower moveable plate 345. The load bellows 350 provided a linear load to lower moveable plate 345 and heat sink 335. This linear load was transferred across the test specimen 340. The load cell 355 was used to determine the pressure across the test specimen 340 (i.e., pressure at the surface interfaces of the screen mesh tested). Five “T” type thermocouples (not shown) were affixed to the centerline of each flux meter to measure temperature differentials.

A control system (not shown) controlled and adjusted the temperatures and pressure until the desired test conditions were met. The control system also collected and stored all the temperature and pressure data for the experiment.

The environment around test specimen 340 may have been entirely evacuated if necessary, thus minimizing convection heat transfer. However, these experiments were ran with an ambient environment, and therefore air was present in the gaps formed by the contacting surface and screen mesh.

Table 1 summarizes the experimental parameters used to ascertain the overall thermal resistance resulting from the insertion of the separator 50 between the two separated steel flux meters 400 with air as the interstitial medium (i.e., air filled the gaps 52 and holes 54 in the screen mesh). The separator 50 was sandwiched between the two flux meters 400 so that the only thermal performance measured was that of the separator 50 and the adjacent flux meter 400 surfaces. The experimental study encompassed a range of interface pressures and temperatures.

TABLE 1

| Screen | | Wire | | | | Mean |
|---|---|---|---|---|---|---|
| Mesh | Mesh | Diameter | | Outer Temp | Inner Temp | Interface |
| Material | Number | (cm) | Interface Pressure (kPa) | (C.) | (C.) | Temp (C.) |
| Stainless | 5 | 0.10414 | 172.4, 344.7, 517.1, 689.5, 1034.2, 1379, | 0 | 93.3 | 16.7, 46.7, 86.7 |
| Steel | | | 1723.7, 2068.4, 2758, 3447.4 | | | |
| Stainless | 10 | 0.0635 | 172.4, 344.7, 517.1, 689.5, 1034.2, 1379, | 0 | 93.3 | 16.7, 46.7, 86.7 |
| Steel | | | 1723.7, 2068.4, 2758, 3447.4 | | | |
| Stainless | 24 | 0.03556 | 172.4, 344.7, 517.1, 689.5, 1034.2, 1379, | 0 | 93.3 | 16.7, 46.7, 86.7 |
| Steel | | | 1723.7, 2068.4, 2758, 3447.4 | | | |
| Titanium | 9 | 0.08128 | 172.4, 344.7, 517.1, 689.5, 1034.2, 1379, | 0 | 93.3 | 16.7, 46.7, 86.7 |
| | | | 1723.7, 2068.4, 2758, 3447.4 | | | |
| Titanium | 14 | 0.04064 | 172.4, 344.7, 517.1, 689.5, 1034.2, 1379, | 0 | 93.3 | 16.7, 46.7, 86.7 |
| | | | 1723.7, 2068.4, 2758, 3447.4 | | | |
| Titanium | 18 | 0.02794 | 172.4, 344.7, 517.1, 689.5, 1034.2, 1379, | 0 | 93.3 | 16.7, 46.7, 86.7 |
| | | | 1723.7, 2068.4, 2758, 3447.4 | | | |
| Tungsten | 8 | 0.0254 | 172.4, 344.7, 517.1, 689.5, 1034.2, 1379, | 0 | 93.3 | 16.7, 46.7, 86.7 |
| | | | 1723.7, 2068.4, 2758, 3447.4 | | | |
| Tungsten | 20 | 0.0127 | 172.4, 344.7, 517.1, 689.5, 1034.2, 1379, | 0 | 93.3 | 16.7, 46.7, 86.7 |
| | | | 1723.7, 2068.4, 2758, 3447.4 | | | |

The experimental results compared the overall thermal resistance or equivalent heat transfer coefficient (hⱼ) to the interface pressure and temperature. In general, the lower the heat transfer coefficient (hⱼ), the greater the overall thermal resistance and the greater the insulating capability.

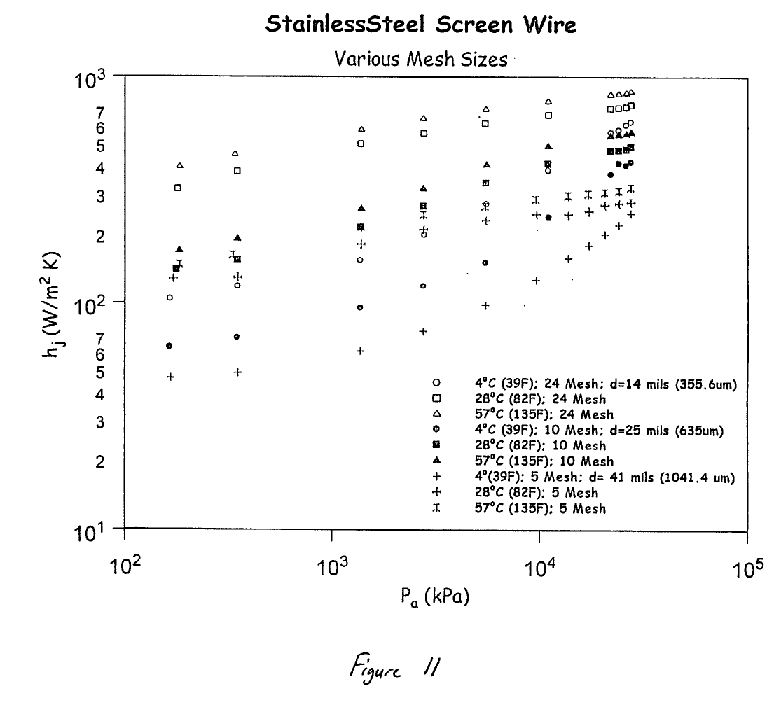

FIG. 11 graphically illustrates the results for all the mesh sizes for the stainless steel screen mesh specimens. The screen mesh with the lowest equivalent heat transfer coefficient was the stainless steel 5 mesh controlled at an interface temperature of about 39° F. and interface pressure of about 175 kPa (25 psi). Without being limited by theory, at higher pressures, the results tended to converge due to the decrease in air gap distance where the thermal contact conductance dominates.

The thickness of the mesh specimens were measured both prior and after a test run and a notable decrease in thickness was found at the higher pressures. This indicated that the specimens may have been deformed at the higher pressures. To limit this preloading effect, fresh screen mesh cutouts were placed in the testing specimen for each new test run.

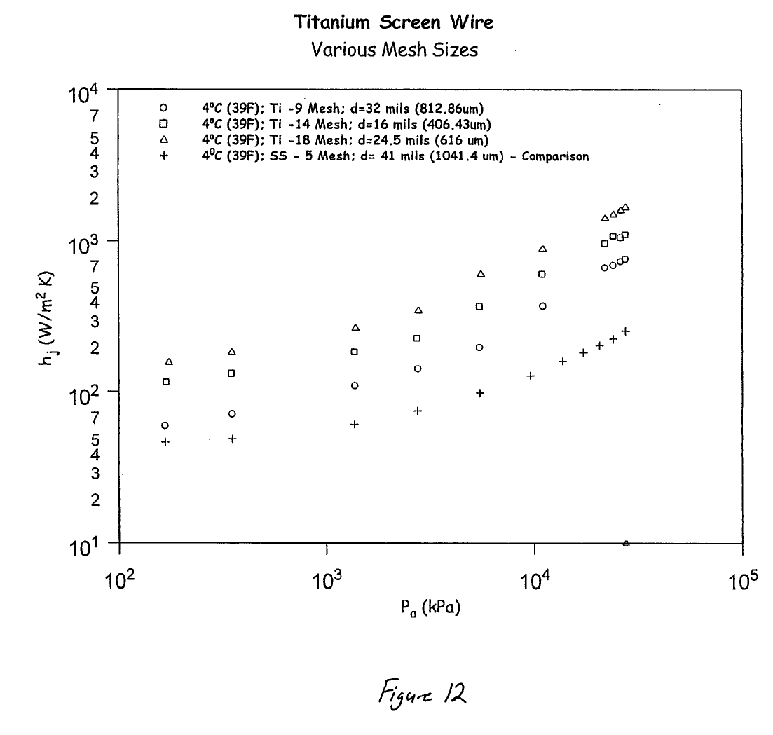

FIG. 12 graphically compares the stainless steel 5 mesh with the titanium screen mesh specimens. The stainless steel 5 screen mesh out-performed the titanium screen mesh. However, since the titanium 9 wire mesh was the smallest mesh number available for testing, it was difficult to definitely conclude that the stainless steel screen mesh was better than the titanium screen mesh. It is to be noted that the cost of titanium screen mesh was considerably higher than the stainless steel screen mesh without any significant improvement in insulating performance.

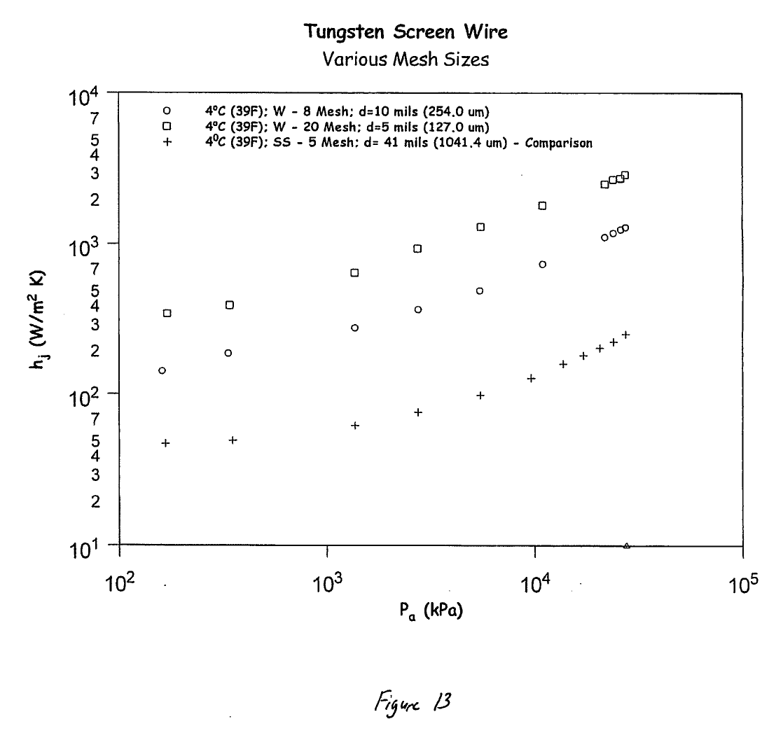

FIG. 13 graphically illustrates the results of the tungsten screen mesh specimens and compares them to the stainless steel 5 mesh. Stainless steel 5 mesh out performed tungsten. Once the best mesh specimen was determined, it was further tested in an assembly similar to a manufactured pipe as shown in EXAMPLE 2.

### EXAMPLE 2

To quantify the thermal performance of an interstitially insulated tubular, controlled experiments were conducted. The experimental facility was appropriate for simulating deepwater applications.

Stainless steel 5 mesh, the best screen mesh specimen as experimentally determined in EXAMPLE 1, was tested in an assembly similar to a manufactured pipe. The stainless steel 5 mesh was tested between two samples of P110 4140 steel (same material as subsea pipes). The total thickness of this composite pipe wall was 19 mm (0.75 in). Also, a sample of P110 4140 steel, 19 mm (0.75 in) in thickness, without the screen mesh was tested to compare how the screen mesh affected the equivalent heat transfer coefficient (hⱼ).

The TCC system 300 illustrated in FIG. 10 and described above was used to conduct the test runs. The experimental study encompassed the range of interface pressures and temperatures typically experienced by subsea pipelines during normal operations. Also, in certain test runs, a sheet of Mylar® film, commercially available from DuPont, was added to the screen mesh tests to determine how the mesh would affect the results.

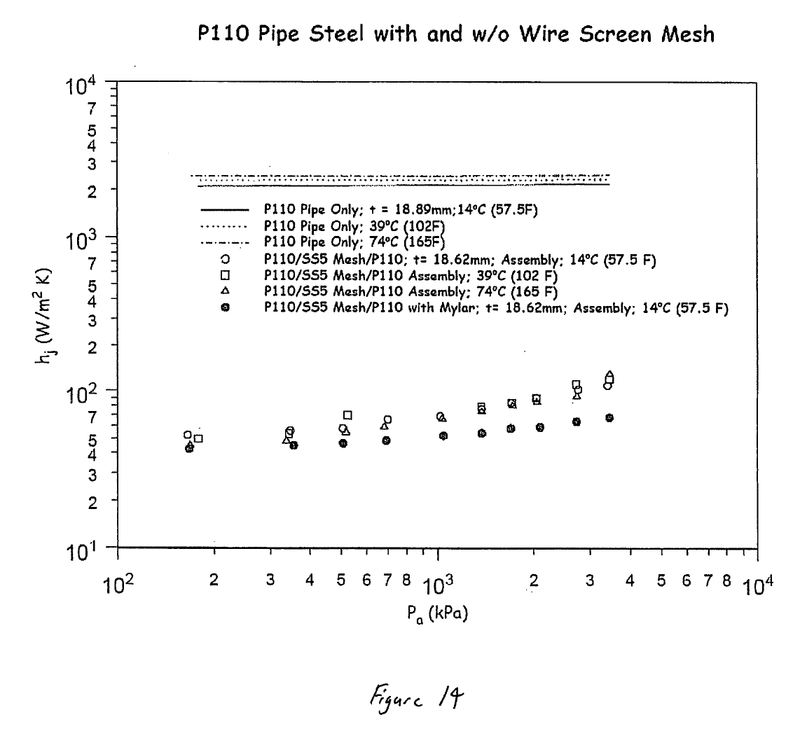

FIG. 14 graphically illustrates the results of this test with a comparison to existing pipe technology currently in use. Without being limited by theory, the experimental data revealed about a two order of magnitude reduction in thermal contact conductance with stainless steel wire screen placed in-between the tubular pipe steel as compared to a tubular pipe thickness without the screen mesh inserted (i.e., 19 mm (0.748 in)). Without being limited by theory, this represented a very large reduction in the pipe thermal conductivity when the stainless steel 5 mesh wire screen was inserted between the steel pipe metal. Further, about an additional 20% reduction in thermal conductance was realized when a sheet of thin (˜12 μm thick (4.7×10⁻⁴ in)) Mylar® film was placed at the two interfaces encompassed by the screen mesh contact points and the solid pipe metal.

Still referring to FIG. 14, the best combination was the stainless steel 5 mesh with Mylar® film in the assembly controlled at a mean interface temperature of about 14.7° C. (57.5° F.). The value for the joint heat transfer coefficient at about 167 kPa is about 42.5 W/m²-K (7.48 Btu/hr ft² ° F.), and it increases to a value of about 67.4 W/m²K (11.9 Btu/hr ft² ° F.) at 3447 kPa (500 psi).

### EXAMPLE 3

To quantify the thermal performance of an interstitially insulated coaxial pipe, controlled experiments were conducted. The experimental facility was appropriate for simulating deepwater applications. Steel slugs made of the same material as subsea pipes (“X-60 or X-80” pipe or medium-carbon steel P110 4140) were used to represent the subsea pipe walls.

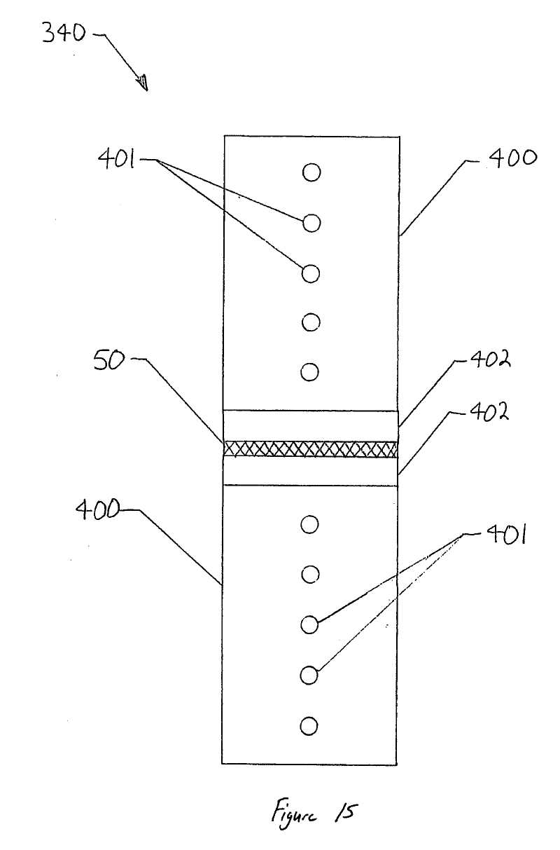

Referring to FIG. 15, each test specimen 340 comprised two flux meters 400, two inserts 402 between the two flux meters 400, and a separator 50 (e.g., screen mesh) positioned between the two inserts 402. The flux meters 400 were fabricated from the steel slugs. Each flux meter 400 had a length of about 3.81 cm (1.5 in.). Five equally spaced holes 401 were drilled to the center of each steel flux meter 400 in order to affix “T” type thermocouples (not shown). The thermocouples measured the axial temperature distributions in the flux meter 400 during testing. The inserts 402 were machined from P110 4140 steel bar stock into cylinders with 1 inch diameters. The machined steel cylinder inserts 402 simulated the inner and outer walls of an interstitial insulating coaxial pipe. The cutouts of separator 50 with a diameter of 2.54 cm (1 inch) were sandwiched between the two cylinder inserts 402, thus mimicking the actual interstitially insulated coaxial pipe under actual temperature and pressure conditions of a subsea environment.

The Thermal Contact Conductance (TCC) system 300 illustrated in FIG. 10 and described above was used to conduct the test runs. Initially, the thermal resistance of the two steel cylinder inserts 402 were measured with just one contacting interface (i.e., with no separator 50 between inserts 402) to obtain a reference value for comparison with the interstitially insulating coaxial pipe. Next, a separator 50 was placed between the two inserts 402 to evaluate the thermal performance of an interstitially insulated coaxial pipe.

The experimental study encompassed the range of interface pressures and temperatures typically experienced by subsea pipelines during normal operations. Table 2 summarizes the experimental parameters used to ascertain the overall thermal resistance resulting from the insertion of the wire screen between the two separated steel inserts with air as the interstitial medium (i.e., air filled the gaps in the screen mesh). In some test runs, an inconel 625 screen mesh was placed between two irregular (e.g., roughened) steel inserts.

TABLE 2

| | | Interface |
|---|---|---|
| | | Tem- |
| | | perature |
| Surface Finish | Interface Pressure (kPa) | (C.) |
| Machine finish | 172.4, 344.7, 517.1, 689.5, 1034.2, 1379, | 17 |
| (not polished) | 1723.7, 2068.4, 2758, 3447.4 | |
| Machine finish | 172.4, 344.7, 517.1, 689.5, 1034.2, 1379, | 47 |
| (not polished) | 1723.7, 2068.4, 2758, 3447.4 | |
| Machine finish | 172.4, 344.7, 517.1, 689.5, 1034.2, 1379, | 87 |
| (not polished) | 1723.7, 2068.4, 2758, 3447.4 | |
| Roughened | 172.4, 344.7, 517.1, 689.5, 1034.2, 1379, | 17 |
| interface | 1723.7, 2068.4, 2758, 3447.4 | |
| surface With | | |
| Inconel | | |
| Roughened | 172.4, 344.7, 517.1, 689.5, 1034.2, 1379, | 47 |
| interface | 1723.7, 2068.4, 2758, 3447.4 | |
| surface With | | |
| Inconel | | |
| Roughened | 172.4, 344.7, 517.1, 689.5, 1034.2, 1379, | 87 |
| interface | 1723.7, 2068.4, 2758, 3447.4 | |
| surface With | | |
| Inconel | | |

The experimental results compared the overall thermal resistance or equivalent heat transfer coefficient (hⱼ) to the interface pressure and temperature.

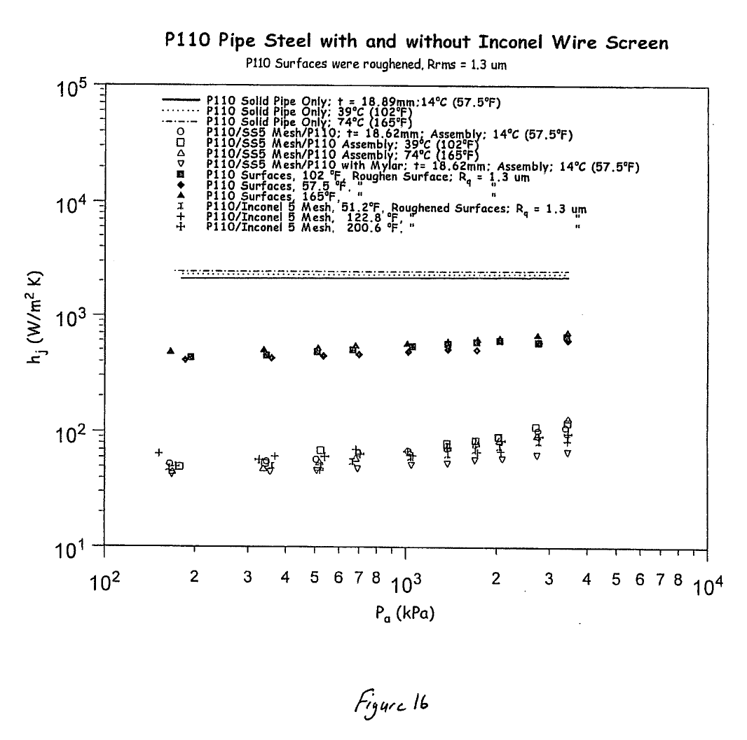

FIG. 16 graphically illustrates the experimental results for inconel as a function of applied interface pressure and interface temperature. A variety of configurations were tested which included a solid P110 steel pipe, P110 steel pipe composed of two steel inserts with roughened contact surfaces, and then a P110 pipe composed of two steel inserts with an inconel wire screen placed between the two inserts. The latter configuration simulated an embodiment of the interstitially insulated tubular of the present invention. The pipe composed of two steel inserts with roughened contact surfaces revealed a thermal joint conductance of about four times less than the solid steel pipe. Further, the pipe composed of two steel inserts with an inconel wire screen placed between the two inserts revealed a thermal joint conductance of about one 10 times less than the pipe composed of two steel inserts with roughened contact surfaces. Still further, the pipe composed of two steel inserts with an inconel wire screen placed between the two inserts revealed a thermal joint conductance of about forty times less than the solid steel pipe pipe configuration.

What is claimed is:

1. An interstitial insulation, comprising:
a material;
a layer mounted to the material;
an interstice disposed between the material and the layer, wherein the interstice is sufficient to reduce heat transfer across the interstitial insulation.

2. The interstitial insulation of claim 1, wherein a separator is disposed in the interstice between the material and the layer.

3. The interstitial insulation of claim 2, wherein the separator comprises a screen mesh.

4. The interstitial insulation of claim 3, wherein the screen mesh is stainless steel.

5. The interstitial insulation of claim 1, wherein at least a portion of a surface of at least one of the material, the layer, or both is irregular.

6. The interstitial insulation of claim 3, wherein the screen mesh prevents the material from contacting the layer when the interstitial insulation is bent.

7. An interstitially insulated tubular, comprising:
an inner tubular;
an outer tubular mounted coaxially to the inner tubular; and
an interstice disposed between the inner tubular and the outer tubular, wherein the interstice is sufficient to reduce heat transfer across the interstitially insulated tubular.

8. The interstitially insulated tubular of claim 7, wherein a high thermal resistance material is disposed in the interstice.

9. The interstitially insulated tubular of claim 8, wherein the high thermal resistance material is a screen mesh.

10. The interstitially insulated tubular of claim 8, wherein the high thermal resistance material separates at least a portion of the inner tubular from at least a portion of the outer tubular.

11. The interstitially insulated tubular of claim 7, wherein at least a portion of a surface of the inner tubular, the outer tubular, or both is irregular.

12. The interstitially insulated tubular of claim 7, wherein the interstice is sufficient for increasing the thermal resistance of the interstitially insulated tubular.

13. The interstitially insulated tubular of claim 7, wherein the outer tubular comprises an inside surface, and further wherein a reflective material is disposed on a least a portion of the inside surface.

14. A method of reducing thermal energy flow across a material, comprising:
(A) mounting a layer to a material;
(B) minimizing the contact surface area between the material and layer; and
(C) providing an interstice between the material and layer, wherein the interstice reduces heat transfer between the material and the layer.

15. The method of claim 14, wherein the material is a tubular, and further wherein the layer is a tubular.

16. The method of claim 15, wherein the material is mounted coaxially to the layer.

17. The method of claim 14, further comprising (D) increasing the thermal resistance of the interstice.

18. The method of claim 17, wherein step (D) comprises providing a separator in the interstice.

19. The method of claim 17, wherein the separator has a high thermal resistance.

20. The method of claim 18, wherein the separator is a stainless steel screen mesh.
